(19) United States
(12) Patent Application Publication
(10) Pub. No.: US 2004/0123308 A1
(43) Pub. Date: Jun. 24, 2004

(54) Hybird of implicit and explicit linkage of windows dynamic link labraries

(75) Inventor: Michael Idoni, Delray Beach, FL (US)

Correspondence Address: Elsa Keller, Intellectual Property Department, Siemens Corporation, 186 Wood Avenue South, Iselin, NJ, 08830, US

(73) Assignee: Siemens Information and Communication Networks, Inc.

(21) Appl. No.: 10/327,297

(22) Filed: Dec. 20, 2002

(51) Int. Cl. G06F 9/00

(52) U.S. Cl. 719/331

(57) ABSTRACT

An improved system and method for loading and linking a dynamic link library (DLL) for use of its entities by an application program. During design, implementation, and production implicit linkage is assumed. Upon load and execution by the computer operating system, explicit linking is assumed resulting in unresolved external references. During execution, the application program invokes DLL loading and linking routines to resolve these external references within the application program's memory space. The application program continues execution and seamlessly invokes DLL entities.

### BACKGROUND OF THE INVENTION

1. Field of the Invention

The present invention relates to computer systems, and in particular, to an improved system and method for linkage of dynamic link libraries.

2. Description of the Related Art

Computer application programs generally utilize a number of separate entities, e.g. objects, functions, and resources. Execution of an application program begins with the main function that makes calls to subsidiary objects or functions and may also utilize resources. In general, separate modules or libraries may hold these entities. Prior to or during execution as a complete program the entities are linked together with the application program using a linker or loaded and invoked explicitly by the application program.

The linker either copies each of the utilized entities into an executable file during the production of the application program (“static linking”) or provides references in the executable file that enable an external set of entities to be mapped when the program is loaded and executed (“dynamic linking”). The linker also provides each of the entities with information identifying the location of other entities so they can access one another. A statically linked executable file can be loaded into the memory and immediately executed independently. A dynamically linked executable file can be loaded into memory but must have any references to external entities resolved and mapped into the application program's memory space, before the execution begins. Generally, “dynamic link libraries” are the central repositories that contain these external entities.

A dynamic link library (DLL) is an application extension module that contains code and data entities that application programs can utilize to perform useful tasks, e.g., directory searches, login commands, character string manipulations, etc. DLLs provide central repositories of these entities that can be used by more than one application without duplication in each executable file.

“Static” linking involves copying any utilized entities into the application program's executable file during production of the executable file. This is illustrated schematically with reference to FIG. 1A. As shown, application program module 1002 and a static library 1004 are provided. The production process 1006 compiles and statically links the application program module 1002 and the static library 1004 and into a single application executable file 1008 that includes all entities necessary to execute and perform the specified task. The resulting application executable 1008 can then be loaded and executed independently by the computer system.

“Dynamic” linking involves using separate application extension files that store the entities application programs require. These entities are loaded and linked prior to their invocations implicitly by the computer system or explicitly by the application program. The separate application extension files referred to in this context are the DLLs described above.

“Implicit” linking involves inserting references to any utilized entities into the application program's executable file by a linker during production of the executable file. To do so, import, or “reference”, libraries corresponding to the contents of DLLs provide information regarding utilized entities. These information references are linked statically in the application executable. Rather than copying code from the DLLs, the linker searches all defined import libraries to find one that contains the necessary information regarding references of any unknown entities. The linker then copies the necessary information from the import library into the application executable to create a dynamic link between the application executable and the DLLs.

Implicit linkage has the advantage that execution is relatively rapid, since the DLL is “pre-loaded” into memory and the statically linked references resolved seamlessly by the computer system when the application program is loaded. However, implicit linkage can be disadvantageous in that the DLL is statically bound by name and references within the application program, which can limit program flexibility. During loading the statically linked references from the import libraries are used to resolve references to external entities.

Implicit linking is illustrated schematically with reference to FIG. 1B. As shown, application program module 1002 and DLL static import library 1005A are provided. The production process 1006 compiles and statically links the application program module 1002 and the DLL static import library 1005A into a single application executable file 1009 that includes references to all entities necessary to execute and perform the specified task. The application executable 1009 cannot be loaded and executed independently by the computer system. The actual DLL 1005B is necessarily loaded and references mapped into memory with the application executable program by the computer operating system 1007 before execution.

“Explicitly” linking involves the application program using standard functions supplied by the computer system static libraries at run time to load any DLLs necessary, retrieve pointers to utilized entities, and invoke these pointers while the computer system is executing the application program. Explicit linkage provides greater flexibility by allowing for the application program to exactly specify, perhaps conditionally, which DLLs and entities to utilize during execution. However, explicit linking can be disadvantageous in that considerable programmatic and associated overhead is required for loading the library, retrieving addresses, and invoking corresponding entities.

Explicit linking is illustrated schematically with reference to FIG. 1C. As shown, application program module 1002 is provided. The production process 1006 compiles and statically links the application program module 1002 and standard computer system static libraries. The application executable 1010 cannot be independently executed by the computer system. The application executable file 1010 includes all entities necessary to be loaded by the computer system but relies on the existence of any DLL that it will attempt to load and retrieve entity references to utilize. The actual DLL 1005B is necessarily existent for loading and referencing entities by the application executable program via standard runtime routines 1011 during execution by the computer system.

### SUMMARY OF THE INVENTION

These and other problems in the prior art are overcome in large part by a system and method according to the present invention. According to the present invention, any relevant DLLs are not loaded and linked when the application program is loaded by the computer system, but loaded and linked with implicit linkage behavior by the application program that determines dynamically, perhaps conditionally, the most appropriate DLLs. That is, the application program specifies any DLLs to load and link with implicit linkage, thereby removing the programmatic and associated overhead of explicit linkage. This also implies the deference of loading and linking done in prior art description of implicit linkage by the computer system.

In short, according to the present invention, explicit linkage is expressed when the application program is loaded so as not to bind any referenced DLLs into the executable file. Upon loading and execution, the application program explicitly loads DLLs and invokes an implicit linkage routine to resolve any imported symbols from the DLL.

In accordance with the present invention, an improved system and method for loading and linking of dynamic link libraries to an application program are provided. During production, DLL import libraries can be statically linked as described with prior art implicit linking. The application would be loaded as described in prior art explicit linking. Upon execution, the application program loads any relevant DLLs and invokes an implicit linkage routine to resolve any external references to be provided by the loaded DLLs.

The present invention thus provides the advantages of both implicit and explicit linking while eliminating much of the programmatic and associated overhead at design, implementation and execution time.

### BRIEF DESCRIPTION OF THE DRAWINGS

A better understanding of the invention is obtained when the following detailed description is considered in conjunction with the following drawings in which:

FIGS. 1A, 1B and 1C are diagrams schematically illustrating static linkage, implicit and explicit dynamic library linkage according to the prior art;

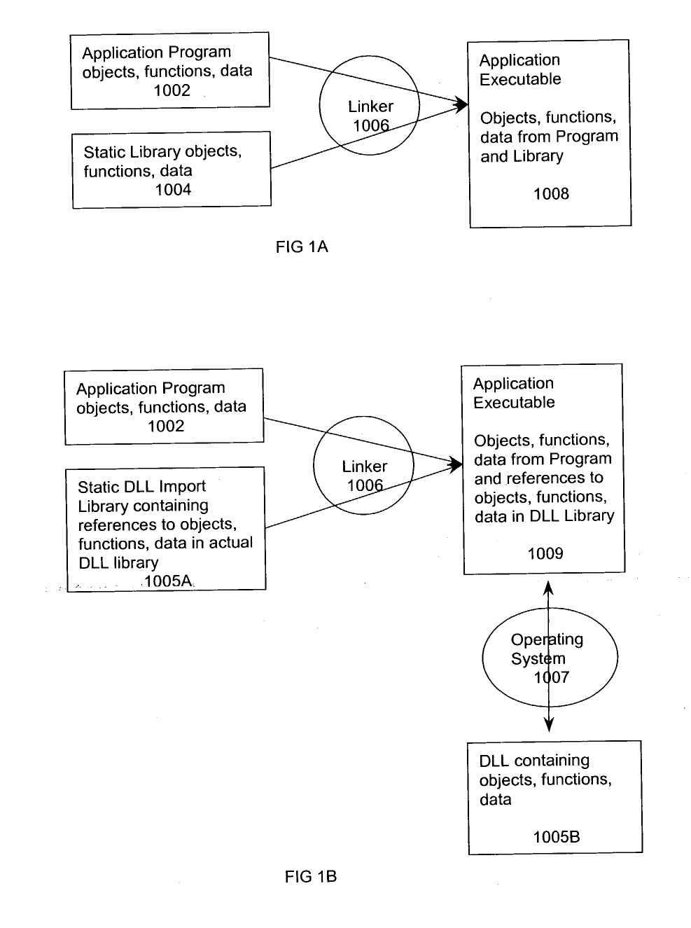

FIG. 2 is a block diagram of an exemplary computer system employing dynamic link library linking according to an embodiment of the present invention;

FIG. 3 is a diagram schematically illustrating dynamic link library linking operation according to an embodiment of the present invention;

FIG. 4 is a flowchart diagram illustrating operation of one implementation of the present invention; and

FIG. 5 is a flowchart diagram illustrating operation of another implementation of the present invention.

### DETAILED DESCRIPTION OF THE INVENTION

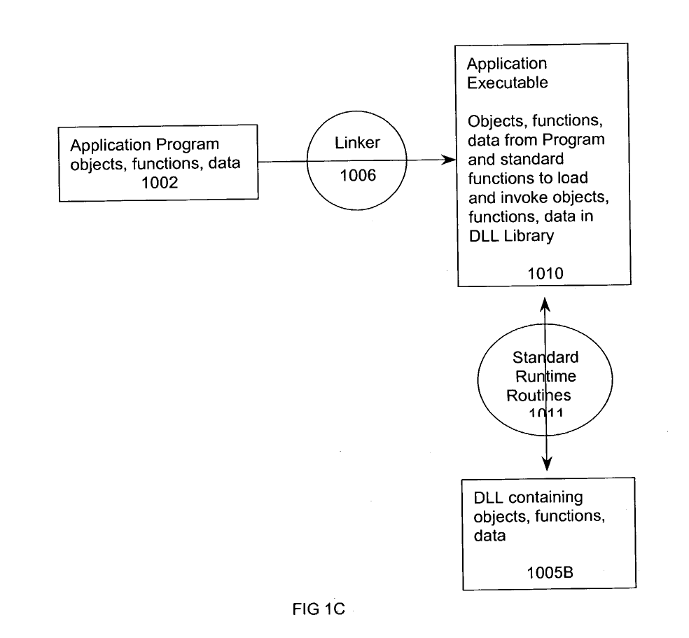

FIGS. 2-5 illustrate a system and method for hybridization of implicit and explicit linkage of dynamic link libraries. As will be discussed in greater detail below, according to an implementation of the present invention, an application program is loaded as specified with explicit linkage. Once the application program has been loaded, an implicit linkage routine is invoked to resolve any external references required for operation of the DLL entities. During program execution, when the DLL function is required, the application program already has resolved the identification of the DLL and reference points, and invocation of the DLL entity can proceed relatively faster than if pure explicit linkage had been implemented and invoked.

Turning now to FIG. 2, a general computer system 100 within which an implementation of the invention may operate is shown. The computer system 100 is capable of loading and executing application programs 102 and DLL application program extensions 104. Further, the computer system 100 is capable of executing loading and linking programs (not shown).

The computer system is representative of a typical hardware configuration having at least one processor 10 and a system bus 12. The processor 10 may be a Pentium or Pentium compatible processor, for example. The system bus 12 may be a Peripheral Component Interconnect (PCI) bus.

The processor 10 is interconnected via the system bus 12 to random access memory (RAM) 14 and a read only memory (ROM) 16. The RAM 14 may be the computer system's 100 main memory and thus be used to store application programs, and DLL reference libraries and the like, according to the present invention, for execution. The processor 10 is further connected via the system bus 12 to an input/output (I/O) adapter 18 for connecting peripheral devices such as disk drive 20 and optical drive 40 to the bus 12, and a user interface adapter 22 for connecting the keyboard 24 and cursor pointing device 26 to the bus 12. Also coupled to the bus 12 may be a display adapter 36 for connecting a display device 38 to the bus 12. Finally, a communication adapter 34 may be provided for connecting the computer system 100 to a data processing network (not shown).

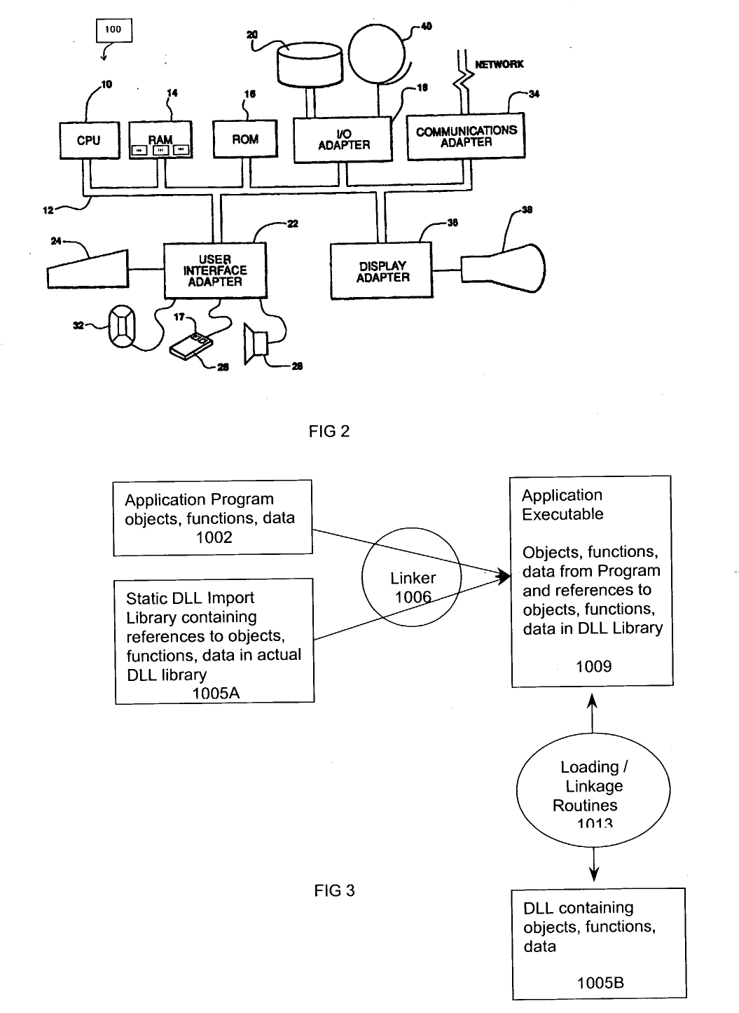

Turning now to FIG. 3, a diagram schematically illustrating operation of one implementation of the present invention is shown. More particularly, the application program 1002 including code appropriate for calling DLL loading and implicit linking routines is provided. Also provided are one or more dynamic link libraries 1005A and a linker 1006. During production, the linker 1006 links the application program 1002 and the DLL Import library 1005A into an application executable file 1009. Like the application program 1002, the application executable 1009 contains the appropriate code to call DLL loading and implicit linkage link routines 1013.

During execution, the application executable 1009 calls the DLL loading and implicit linkage routines 1013 to resolve any external references necessary to DLL 1005B. The application executable 1009 then executes as normal as if the DLL had been implicitly linked by the computer operating system upon program start up.

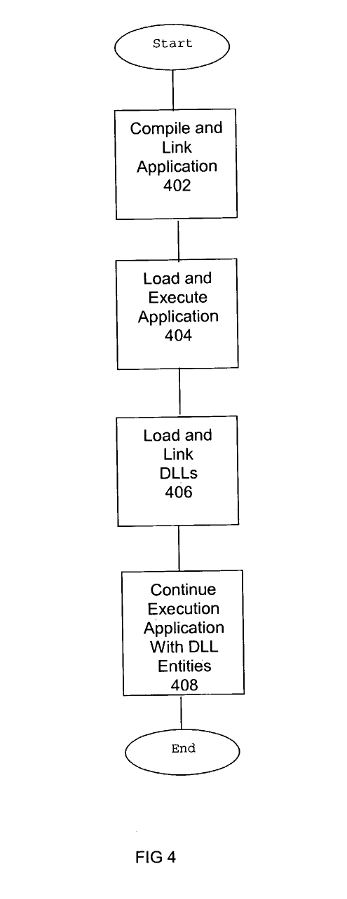

Turning now to FIG. 4, a flowchart illustrating operation of this implementation of the invention is shown. In a step 402, an application program is compiled and linked. The resulting application executable file is then run, in a step 404. During execution, if DLL references are to be invoked, the application executable calls the loading and linking routines in a step 406. The linking program then continues with resolved external references to the DLL entities in a step 408.

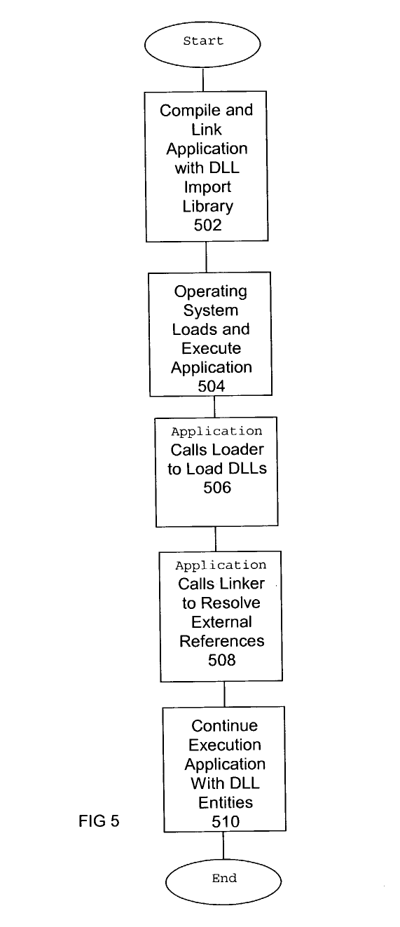

This process is illustrated in greater detail with reference to FIG. 5. During production, in a step 502, compilation and linking as defined for implicit linkage results in an application program with unresolved external references to entities in DLLs. That is, a set of import libraries specifying one or more DLLs required by the application program is statically linked with the application program. In a step 504, the application program is loaded and executed by the computer operating system as defined for explicit linkage, including the unresolved references provided by the import libraries specified in step 502. In a step 506, the executing application invokes the DLL loader routine for any necessary DLLs. Included in the call to the loader routine is an identification and physical location of the DLL. In a step 508, the executing application invokes the linker routine to resolve any external references. Included in the call to the linker program is a memory base address of the loaded DLL necessary to resolve external references. In a step 510, the application executable continues as normal invoking entities provided by the DLLs seamlessly.

The invention described in the above detailed description is not intended to be limited to the specific form set forth herein, but is intended to cover such alternatives, modifications and equivalents as can reasonably be included within the spirit and scope of the appended claims.

What is claimed is:

1. A method for loading and linking a dynamic link library (DLL) by an application program having unresolved external DLL references at execution time, comprising the steps of:
loading appropriate DLLs in response to unresolved references;
linking unresolved references to the loaded DLL entities; and
invoking the DLL references during execution of the application program.

2. The method of loading and linking a DLL by an application program of claim 1 further comprising the step of:
compiling and linking the application program as defined for implicit linkage, resulting in the unresolved external DLL references, prior to the execution of the compiled application program.

3. The method of loading and linking a DLL by an application program of claim 1, wherein resolution of the DLL references is caused by calls by the executing application program to DLL loader and linker routines for any necessary DLLs.

4. The method of loading and linking a DLL by an application program of claim 3, wherein the DLL loader routine is provided with the identification and physical location of the necessary DLLs.

5. The method of loading and linking a DLL by an application program of claim 3, wherein calls to the linker routine comprises the executing application program providing a memory base address of the necessary DLLs to resolve external references.

6. A system for loading and linking a dynamic link library (DLL) by an application program having unresolved external DLL references at execution time, comprising:
a memory; and
a processor coupled to the memory, the processor configured to store the application program in the memory and call loader and linker routines and invoke DLL references while the application program is executing, the linker program configured to link a DLL to the application program.

7. The system for loading and linking a DLL by an application program of claim 6, wherein the processor is further configured to compile and link the application program as defined for implicit linkage, resulting in the unresolved external DLL references, prior to the execution of the compiled application program.

8. The system for loading and linking a DLL by an application program of claim 6, wherein the processor is further configured to permit resolution of the DLL references to be caused by calls by the executing application program to DLL loader and linker routines for any necessary DLLs.

9. The system for loading and linking a DLL by an application program of claim 8, wherein the DLL loader routine is provided with the identification and physical location of the necessary DLLs.

10. The method of loading and linking a DLL by an application program of claim 8, wherein calls to the linker routine comprises the executing application program providing a memory base address of the necessary DLLs to resolve external references.

11. A computer-readable medium having stored thereon a plurality of instructions, the plurality of instructions including instructions which, when executed by a processor, cause the processor to load and link a dynamic link library (DLL) by an application program having unresolved external DLL references at execution time, by:
loading appropriate DLLs in response to unresolved references;
linking unresolved references to the loaded DLL entities; and
invoking the DLL references during execution of the application program.

12. The computer-readable medium of claim 11, wherein the plurality of instructions includes further instructions which, when executed by a processor, cause the processor to perform the additional step of:
compiling and linking the application program as defined for implicit linkage, resulting in the unresolved external DLL references, prior to the execution of the compiled application program.

13. The computer-readable medium of claim 11, wherein resolution of the DLL references is caused by calls by the executing application program to DLL loader and linker routines for any necessary DLLs.

14. The computer-readable medium of claim 13, wherein the DLL loader routine is provided with the identification and physical location of the necessary DLLs.

15. The computer-readable medium of claim 13, wherein calls to the linker routine comprises the executing application program providing a memory base address of the necessary DLLs to resolve external references.

16. A system for loading and linking a dynamic link library (DLL) by an application program having unresolved external DLL references at execution time, comprising:
means for loading appropriate DLLs in response to unresolved references;
means for linking unresolved references to the loaded DLL entities; and
means for invoking the DLL references during execution of the application program.

17. The system for loading and linking a DLL by an application program of claim 16, further comprising means for compiling and linking the application program as defined for implicit linkage, resulting in the unresolved external DLL references, prior to the execution of the compiled application program.

18. The system for loading and linking a DLL by an application program of claim 16, wherein resolution of the DLL references is caused by calls by the executing application program to DLL loader and linker means for any necessary DLLs.

19. The system for loading and linking a DLL by an application program of claim 18, wherein the DLL loader means is provided with the identification and physical location of the necessary DLLs.

20. The system for loading and linking a DLL by an application program of claim 18, wherein calls to the linker means comprises the executing application program providing a memory base address of the necessary DLLs to resolve external references.
